(19) United States
(12) Patent Application Publication
(10) Pub. No.: US 2024/0067802 A1
(43) Pub. Date: Feb. 29, 2024

(54) GRAPHENE ENHANCED SHEET MOLDING COMPOUND

(71) Applicant: Magna Exteriors Inc., Aurora (CA)

(72) Inventors: Ranjit Pachha, Brampton (CA); Siddhartha Asthana, Ann Arbor, MI (US)

(73) Assignee: Magna Exteriors Inc., Aurora, ON (CA)

(21) Appl. No.: 18/259,156

(22) PCT Filed: Dec. 23, 2021
(86) PCT No.: PCT/US2021/065127

§ 371 Date: Jun. 23, 2023

Related U.S. Application Data
(60) Provisional application No. 63/130,136, filed on Dec. 23, 2020.

(51) Int. Cl. C08K 7/06; C08J 3/22; C08K 3/04; C08K 7/14

(52) U.S. Cl. CPC C08K 7/06; C08J 3/226; C08K 3/042; C08K 7/14; C08J 2333/06; C08J 2367/06; C08J 2433/04; C08J 2467/00

(57) ABSTRACT

A glass filled SMC composition having an effective amount of graphene for providing improved Izod impact strength, flexural strength and tensile properties over and SMC composition without graphene as an additive.

### CROSS-REFERENCE TO RELATED APPLICATIONS

This application is a PCT International Application and claims benefit of United States Provisional Patent Application No. 63/130,136, filed Dec. 23, 2020. The disclosure of the above application is incorporated herein by reference.

### FIELD OF THE INVENTION

The present invention relates to graphene enhanced sheet molding compound.

### BACKGROUND OF THE INVENTION

Graphene has been shown to improve properties of epoxy pre-preg with respect to inter laminar shear properties. For instance, the following articles talk about various aspects of using graphene prepregs. There have been no known teachings of use in automotive SMC compositions, but the following articles may be of interest:
a) Thesis: Interfacial Toughening of Carbon Fiber Reinforced Polymer (CFRP) Matrix Composites Using Graphene Oxide Containing Nanofibers; Middle East Technical University.
b) Recent Developments in Graphene Oxide/Epoxy Carbon Fiber Reinforced Composites; Frontiers in Materials 2019.
c) A Novel Pi Bridging Method to Graft Graphene Oxide onto Carbon Fiber to Enhance Interfacial Enhancement of Epoxy Composite; Composite Science and Technology 2021.

Additionally, use of graphene in carbon SMC has been reported by Manotek Industries for producing conductive bipolar plates which is shown in U.S. Pat. Nos. 8,597,453 and 10,236,500 for instance. This work done by Manotek with graphene in carbon SMC was to improve the conductivity of the composite and not for use in automotive parts or the like.

Sheet molding compounds are used for metals replacement in automotive structural components. Some parts of interest are reinforcement for liftgate, doors, hoods, roof and pick up boxes. These composite applications in automotive require high stiffness and impact properties while having low part weight (as compared to metals). Increasing fiber length or fiber content to increase mechanical properties lead to processing issues during manufacturing. Hence there is a need to increase the mechanical properties of the sheet molding compound material without increasing the weight.

It is therefore a goal to incorporate graphene in glass filled sheet molding compounds (SMC) at to improve mechanical properties of SMC at low dosage and if possible, introduce graphene as sizing on carbon fiber.

### SUMMARY OF THE INVENTION

A glass filled SMC composition having an effective amount of graphene for providing improved Izod impact strength, flexural strength and tensile properties over and SMC composition without graphene as an additive.

Our work has shown that incorporation of a small amount of graphene (0.05-1% by weight) in fiber filled SMC leads to mechanical property improvements which allows manufacture of lightweight and robust structural and cosmetic vehicle parts.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### BRIEF DESCRIPTION OF THE DRAWINGS

The present invention will become more fully understood from the detailed description and the accompanying drawings, wherein:

FIG. 1 is a schematic view of combined properties of the graphene enhanced SMC compositions of the present invention;

FIGS. 2A and 2B are bar graphs showing the tensile properties of example compositions of the present invention;

FIGS. 3A and 3B are bar graphs showing the flexural properties of example compositions of the present invention;

FIG. 4 is a bar graph showing the tensile properties of example compositions of the present invention;

FIG. 5 is a schematic showing the steps for producing a three-layer SMC sheet in accordance with the present invention, and,

FIG. 6 is a graph showing physical property results of additions of graphene in a glass filled SMC composition.

### DETAILED DESCRIPTION OF THE PREFERRED EMBODIMENTS

The following description of the preferred embodiment(s) is merely exemplary in nature and is in no way intended to limit the invention, its application, or uses.

In accordance with the present invention a glass or carbon fiber filled SMC composition having an effective amount of graphene for providing improved Izod impact strength, flexural strength and tensile properties over and SMC composition without graphene as an additive is provided. In a preferred embodiment the effective amount of graphene is from about 0.025-1% and preferably 0.05-0.5% by weight graphene. flexural strength, Izod impact strength and tensile properties are improved over SMC compositions without graphene. In the present invention tensile and flex properties of carbon SMC are improved by 15-20% and impact properties by greater than 30%.

SMC compositions useful in the present invention are the commonly used filled polyester epoxy type resins which are 20 to 80% by volume resin mixed with 20 to 80% by volume glass or carbon fiber fillers. Preferably fillers are found in amounts of between 40-60%. Suitable compositions are set forth in the commonly assigned U.S. Pat. No. 11,053,364 which is incorporated herein by reference. A preferred SMC compound is a Magna EPIC Blend™ SMC composition available from Magna International, Novi, Michigan. The SMC is a vinyl ester type sheet molding composition. Other fillers, additives and components may be included in minor amounts.

The carbon fiber has predetermined sizing and large tow suitable for formulation with the SMC chosen and which provides suitable predetermined desired properties. A preferred material for use in the present invention is a Panex® 35 Continuous Tow (50K) carbon fiber material available from Zoltek Companies, Inc. St. Louis, Missouri. This material is a 50K filament fiber manufactured from polyacrylonitrile precursor. The material has a tensile strength of 600 ksi, a tensile modulus of 35 msi, an electrical resistivity of 0.00061 ohm-in, a fiber diameter of 0.283 mils, a carbon content of 95%, and a yield of 400 ft/lb.

For Carbon SMC-masterbatch of graphene in vinyl ester resin is further blended in vinyl ester resin containing catalyst, inhibitor, mold release agent and thickening agent-2,4 MDI-Methylene diphenyl diisocyanate. This resin blend is poured into both the doctor box on a release film made with a combination of polyethylene on one side and polyamide/polyester on other side. The fiber glass is chopped on to the resin layer and sandwiched between two release films. The resin and chopped carbon fiber form a uniformly mixed combination of resin/fiber in the compactor. The SMC is then thickened for 48 hours and during molding the release film is removed and the carbon/resin SMC is placed in mold and compression molded.

For Glass SMC-the resin is typically unsaturated polyester or combination of polyester/vinyl ester resin, and the same procedure is followed except carbon fiber is replaced with glass fiber.

Suitable graphene additives are utilized as set forth above. Preferably the graphene material is selected from the group consisting of AGnP-10, AGnP-35 (available from Applied Graphene Materials plc, Cleveland, United Kingdom) and C-300, R10 (available from XG Sciences, Lansing, Michigan), and mixtures thereof. Preferably they are used as a sizing on the graphite material however they can be separately added at the doctor boxes.

In accordance with the present invention, the carbon filled SMC composition has a flexural strength of generally from about 243 MPa to about 551 MPa; typically from about 400 MPa to about 500 MPa; and, preferably from about 450 MPa to about 500 MPa; an Izod impact strength of generally from about 192 J/m to about 445 J/m; typically from about 290 J/m to about 445 J/m; and, preferably from about 300 J/m to about 425 J/m and the tensile properties are generally from about 198 MPa to about 400 MPa typically from about 250 MPa to about 325 MPa and preferably from about 260 MPa to about 300 MPa.

Suitable graphene additives are utilized as set forth above. Preferably the graphene material is selected from the group consisting of AGnP-10, AGnP-35 (available from Applied Graphene Materials plc, Cleveland, United Kingdom) and R10 (available from XG Sciences, Lansing, Michigan), and mixtures thereof. A high degree of exfoliation of the graphene which provides improvement in properties is required. As shown in the figures the C-300 material is not sufficiently exfoliated to provide the critical property improvements desired in the present invention. Thus, it is preferred that the partical size diameter of the Graphene be greater than 2 microns and have a high degree of exfoliation.

In the present invention a vehicle part is made from SMC sheet molding composition including from about 0.05-1% by weight graphene. These parts are stronger than other like parts and therefore lighter weight sturdier parts such as hoods, tops, fenders, trunk lids and liftgates can be produce due to the SMC of the present invention. The process of making a vehicle part which includes a flexural strength of generally from about 243 MPa to about 551 MPa; typically from about 400 MPa to about 500 MPa; and, preferably from about 450 MPa to about 500 MPa; an Izod impact strength of generally from about 192 J/m to about 445 J/m; typically from about 290 J/m to about 445 J/m; and, preferably from about 300 J/m to about 425 J/m and the tensile properties are generally from about 198 MPa to about 400 MPa; typically from about 250 MPa to about 325 MPa; and preferably from about 260 MPa to about 300 MPa, comprises molding apart from a sheet molding composition containing from about 0.05 to about 1% of a graphene material.

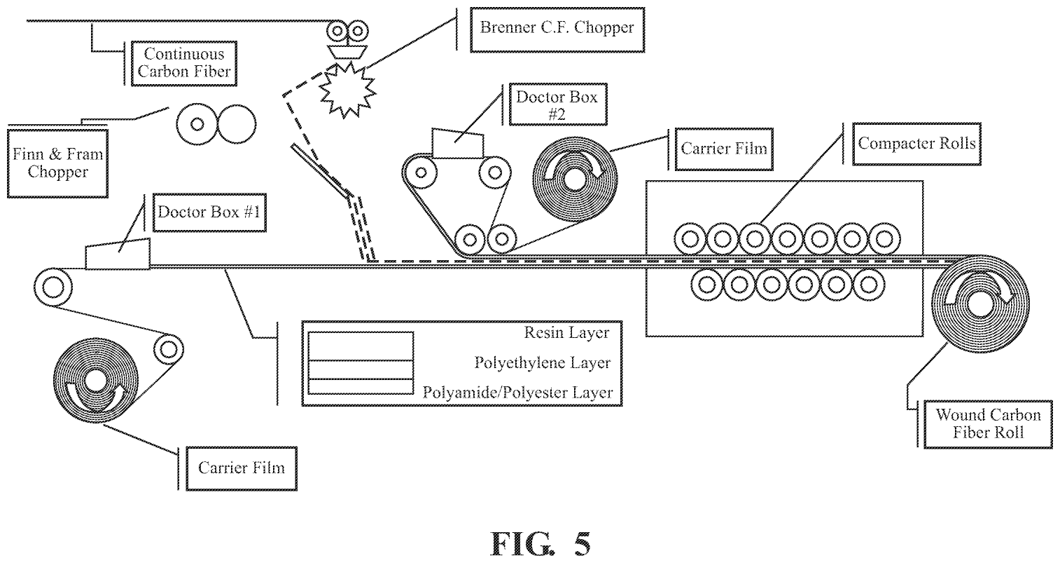

As shown in FIG. 5 there is provided a process of making a three-layer SMC in accordance with the present invention. The three layers include a resin layer, a polyethylene layer and polyamide/polyester layer, typically the graphene material is added to the resin layer by adding it to the continuous carbon fiber prior to the chopper. However, graphene can also be added in doctor box 1 or doctor box 2. Further information with respect to manufacturing SMCs in accordance with the present invention is found in commonly assigned U.S. Pat. No. 11,072,093 which is incorporated by reference herein.

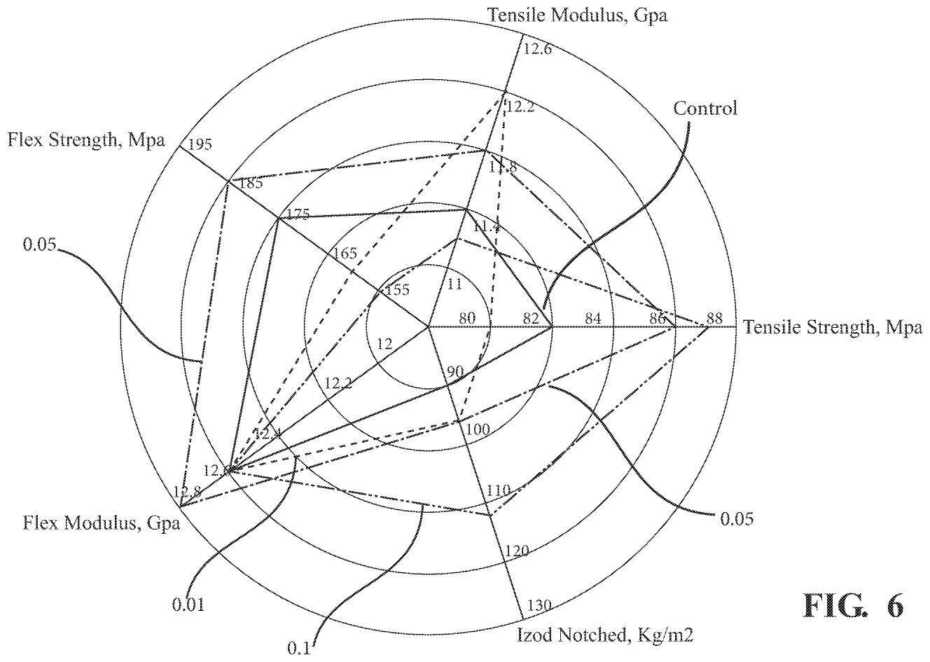

Referring to FIG. 6 with respect to SMC glass filled compositions the properties achieved include: a flexural strength of generally from about 176 MPa to about 200 MPa; typically from about 180 MPa to about 190 MPa; and, preferably from about 182 MPa to about 187 MPa; an Izod impact strength of generally from about 97 Kg/m² to about 120 Kg/m²; typically from about 98 Kg/m² to about 110 Kg/m²; and, preferably from about 98 Kg/m² to about 100 Kg/m² and the tensile strength properties are generally from about 83 MPa to about 130 MPa; typically from about 84 MPa to about 125 MPa; and preferably from about 84 MPa to about 88 MPa.

The graphene enhanced fiber filled SMC material thus produced can be used in the same molds and techniques as presently used for SMC molding. As stated above parts having less thickness and weight are produced with the SMC composition of the present invention. Such parts include liftgate reinforcement panels, door panels, hoods, roof panels, pickup beds, bumpers, quarter panels, and fascia support members.

### Example 1

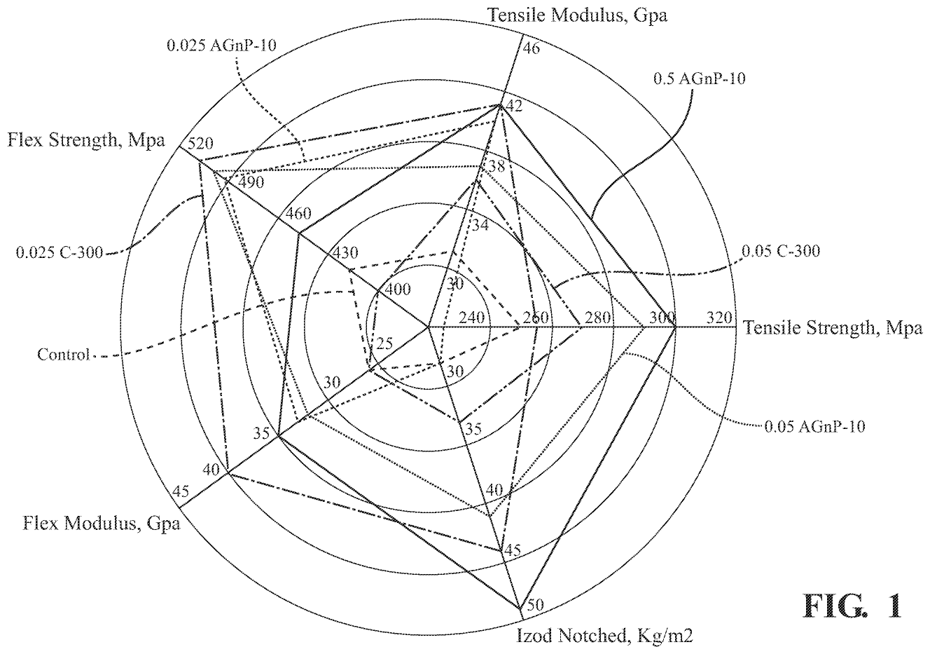

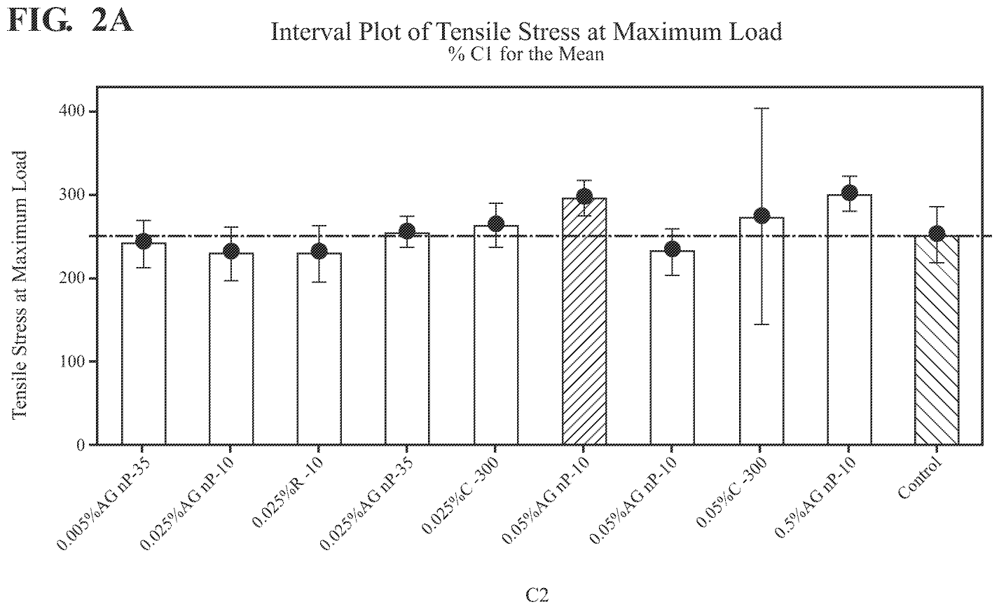

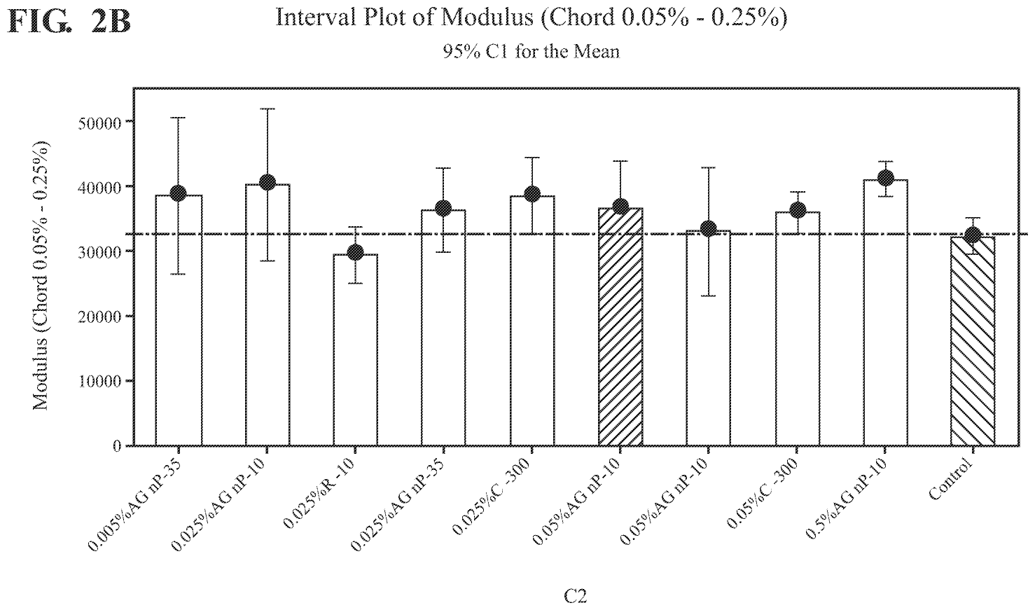

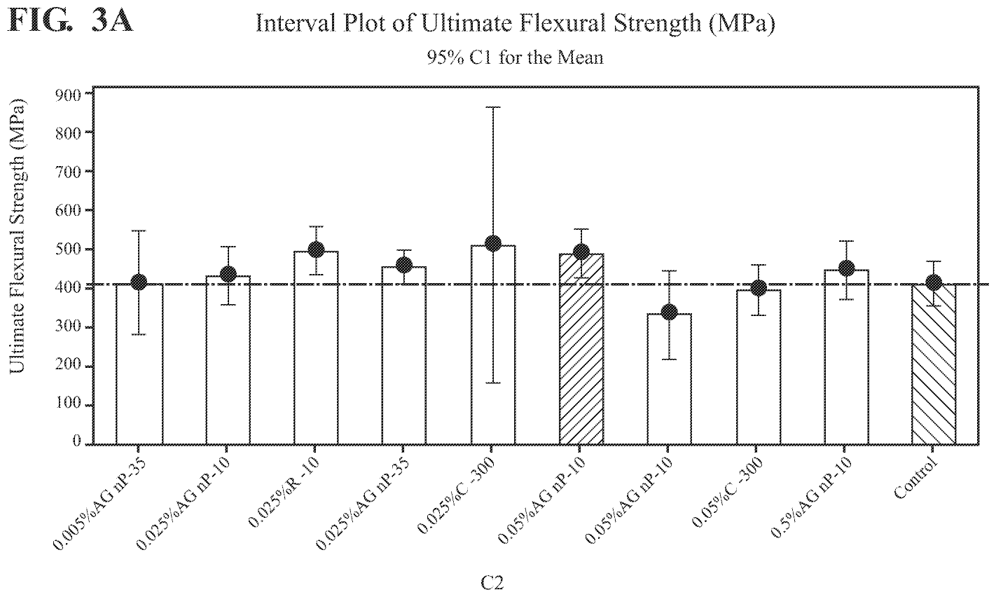

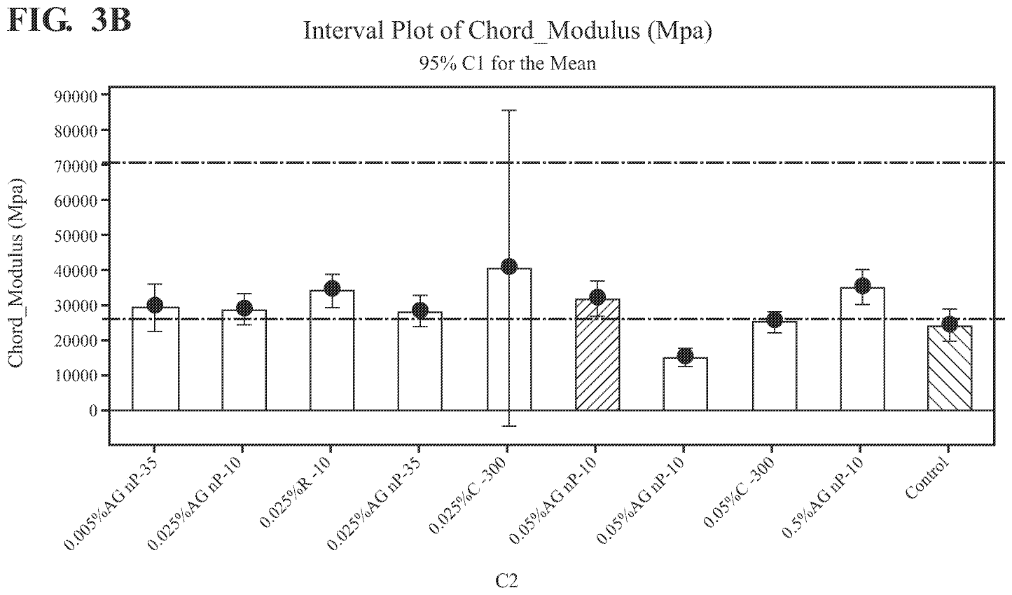

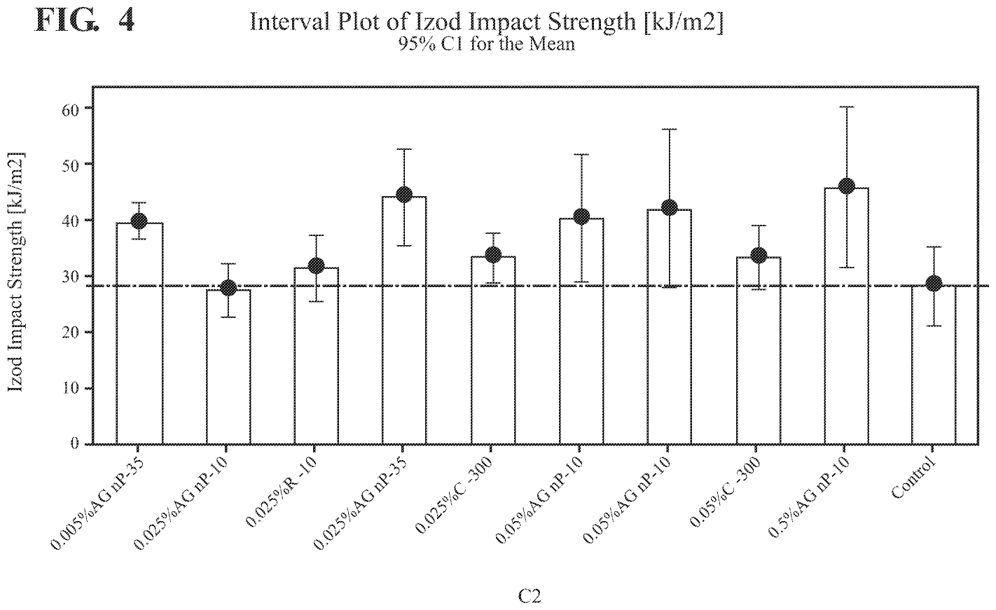

Master batches of graphene are prepared using 0.025, 0.05, 0.5 and 1% graphene for each of by weight of each AGnP-10, AGnP-35, C-300, and R10 in a CFS resin formulation. This is compounded with a Zoltec carbon fiber using a Brenner chopper. Test pieces of one-foot square compression molded plaques are formed and tested for tensile strength, flexural strength, and Izod impact strength. Control formulations are made using the same SMC components and Zoltec carbon fiber. The results are found to have improvements in tensile strength, Izod impact strength and flexural strength over the controls containing no graphene as shown in FIG. 1.

### Example 2

Master batches of graphene are prepared using 0.025, 0.05, 0.5 and 1% graphene for each of by weight of each AGnP-10, AGnP-35, C-300, and R10 in an SMC resin formulation. This is compounded with a glass fiber using a Brenner chopper. Test pieces of one-foot square compression molded plaques are formed and tested for tensile strength, flexural strength, and Izod impact strength. Control formulations are made using the same SMC components and Zoltec carbon fiber. The results are found to have improvements in tensile strength, Izod impact strength and flexural strength over the controls containing no graphene as shown in FIG. 6.

The description of the invention is merely exemplary in nature and, thus, variations that do not depart from the essence of the invention are intended to be within the scope of the invention. Such variations are not to be regarded as a departure from the spirit and scope of the invention.

What is claimed is:

1. A glass or carbon fiber filled SMC composition having an effective amount of graphene for providing improved Izod impact strength, flexural strength and tensile properties over an SMC composition without graphene as an additive.

2. The glass or carbon fiber filled SMC composition of claim 1 wherein said effective amount of graphene is from about 0.05-1% by weight graphene.

3. The glass or carbon fiber filled SMC composition of claim 1 wherein flexural strength, Izod impact strength and tensile properties are improved by at least 30% over SMC compositions without graphene.

4. The glass or carbon fiber filled SMC composition of claim 2 wherein the composition is carbon fiber filled.

5. The glass or carbon fiber filled SMC composition of claim 4 wherein the carbon fiber includes the graphene as a sizing on the carbon fibers.

6. The glass or carbon fiber filled SMC composition of claim 5 wherein the flexural strength is from about 243 MPa to about 551 MPa.

7. The glass or carbon fiber filled SMC composition of claim 5 wherein the Izod impact strength is from about 192 J/m to about 445 J/m.

8. The glass or carbon fiber filled SMC composition of claim 5 wherein the tensile properties are from about 198 MPa to about 400 MPa.

9. The glass or carbon fiber filled SMC composition of claim 5 comprising the following properties: a flexural strength of generally from about 243 MPa to about 551 MPa; typically from about 400 MPa to about 500 MPa; and, preferably from about 450 MPa to about 500 MPa; an Izod impact strength of generally from about 192 J/m to about 445 J/m; typically from about 290 J/m to about 445 J/m; and, preferably from about 300 J/m to about 425 J/m and the tensile properties are generally from about 198 MPa to about 400 MPa; typically from about 250 MPa to about 325 MPa; and preferably from about 260 MPa to about 300 MPa.

10. The glass or carbon fiber filled SMC composition of claim 1 wherein the graphene material is selected from the group consisting of AGnP-10, AGnP-35, R10 and mixtures thereof.

11. The glass or carbon fiber filled SMC composition of claim 2 wherein the composition is glass filled.

12. The glass or carbon fiber filled SMC composition of claim 11 wherein the composition a flexural strength of generally from about 176 MPa to about 200 MPa; typically from about 180 MPa to about 190 MPa; and, preferably from about 182 MPa to about 187 MPa; an Izod impact strength of generally from about 97 Kg/m² to about 120 Kg/m²; typically from about 98 Kg/m² to about 110 Kg/m²; and, preferably from about 98 Kg/m² to about 100 Kg/m² and the tensile strength properties are generally from about 83 MPa to about 130 MPa; typically from about 84 MPa to about 125 MPa; and preferably from about 84 MPa to about 88 MPa.

13. A vehicle part made from a carbon fiber filled SMC composite material comprising: a sheet molding composition including from about 0.05-1% by weight graphene including a flexural strength of generally from about 243 MPa to about 551 MPa; typically from about 400 MPa to about 500 MPa; and, preferably from about 450 MPa to about 500 MPa; an Izod impact strength of generally from about 192 J/m to about 445 J/m; typically from about 290 J/m to about 445 J/m; and, preferably from about 300 J/m to about 425 J/m and the tensile properties are generally from about 198 MPa to about 400 MPa; typically from about 250 MPa to about 325 MPa; and preferably from about 260 MPa to about 300 MPa.

14. The vehicle part of claim 11 wherein the graphene is sized on the carbon fiber prior to mixing of the SMC compound.

15. A vehicle part made of a glass filled SMC which includes from about 0.05 to 1.0% by weight graphene which has the properties of a flexural strength of generally from about 176 MPa to about 200 MPa; typically from about 180 MPa to about 190 MPa; and, preferably from about 182 MPa to about 187 MPa; an Izod impact strength of generally from about 97 Kg/m² to about 120 Kg/m²; typically from about 98 Kg/m² to about 110 Kg/m²; and, preferably from about 98 Kg/m 2 to about 100 Kg/m 2 and the tensile strength properties are generally from about 83 MPa to about 130 MPa; typically from about 84 MPa to about 125 MPa; and preferably from about 84 MPa to about 88 MPa.

16. A process of making a vehicle part comprising molding a part from a sheet molding composition containing from about 0.05 to about 1% of a graphene material having the following properties: a vehicle part made from and SMC composite material comprising: an sheet molding composition including from about 0.05-1% by weight graphene wherein a flexural strength of generally from about 243 MPa to about 551 MPa; typically from about 400 MPa to about 500 MPa; and, preferably from about 450 MPa to about 500 MPa; an Izod impact strength of generally from about 192 J/m to about 445 J/m; typically from about 290 J/m to about 445 J/m; and, preferably from about 300 J/m to about 425 J/m and the tensile properties are generally from about 198 MPa to about 400 MPa; typically from about 250 MPa to about 325 MPa; and preferably from about 260 MPa to about 300 MPa.

17. The process of claim 16 wherein the SMC is filled with 40 to 60% by volume carbon fiber reinforcement.

18. The process of claim 17 wherein the graphene is added as a part of the sizing of the carbon fiber.

19. A process of making a vehicle part comprising molding a part from a sheet molding composition containing from about 0.05 to about 1% of a graphene material the following properties: a vehicle part made from and SMC composite material comprising: a glass filled sheet molding composition including from about 0.05-1% by weight graphene wherein the SMC of the part includes a flexural strength of generally from about 176 MPa to about 200 MPa; typically from about 180 MPa to about 190 MPa; and, preferably from about 182 MPa to about 187 MPa; an Izod impact strength of generally from about 97 Kg/m² to about 120 Kg/m²; typically from about 98 Kg/m² to about 110 Kg/m²; and, preferably from about 98 Kg/m² to about 100 Kg/m² and the tensile strength properties are generally from about 83 MPa to about 130 MPa; typically from about 84 MPa to about 125 MPa; and preferably from about 84 MPa to about 88 MPa.

20. The process of claim 19 wherein the glass fiber is found in the SMC in amounts of from about 40 to about 60% by volume.
